(19) United States
(12) Patent Application Publication
(10) Pub. No.: US 2008/0141742 A1
(43) Pub. Date: Jun. 19, 2008

(54) Locking Arrangement

(75) Inventor: David Martin Stuckey, Victoria (AU)

Correspondence Address: VENABLE, CAMPILLO, LOGAN & MEANEY, P.C., 1938 E. OSBORN RD, PHOENIX, AZ, 85016-7234, US

(73) Assignee: BURGUNDY TRIAL PTY LTD., Thomastown, VI (AU)

(21) Appl. No.: 11/571,566

(22) PCT Filed: Jan. 24, 2006
(86) PCT No.: PCT/AU06/00089

§ 371 Date: Jan. 2, 2007

(30) Foreign Application Priority Data
Jan. 24, 2005 (AU) 2005900275

(51) Int. Cl. E05B 65/12; E05B 47/00; E05B 65/36

(52) U.S. Cl. 70/224; 70/275; 70/276

(57) ABSTRACT

A locking arrangement (10) comprising a lockable handle assembly (31) having an independent locking mechanism (30), which mechanism cooperates with an engagement means (61) operable by an actuator (60), said actuator itself being operable by a vehicle's central locking system (not shown), wherein when the engagement means (61) is place in lockable contact with the locking mechanism (30) of the handle assembly (31) by the actuator (60), the locking arrangement (10) is placed in a locked condition.

### FIELD OF THE INVENTION

The present invention relates to locking arrangement, preferably a locking arrangement for use with a lockable access point such as doors, storage containers, compartments, covers/hatches, transport boxes and bags and the like on vehicles including motor vehicles or cycles. The invention is also to a method for reversibly locking the access point.

The locking arrangement is one that is operable by the central locking system of a motor vehicle, for example, a car, truck, bus or motorcycle.

### BACKGROUND OF THE INVENTION

Transport/delivery trucks are often configured for security reasons with enclosed rear van areas, whereby access to the goods located therein is via one or more lockable doors. Similarly, recreational vehicles including mobile homes often contain hollow compartments that act as storage areas, where access to the inside of the compartment is via doors or hatches located on the outside of the vehicle's body.

A tradesperson's vehicle in the form of a motor vehicle utility often has one or more toolboxes or storage containers mounted on the utility's tray in which the tradesperson will store his/her tools. Sometimes, the open tray area of the utility can be covered with a solid hatch to protect and secure cargo thereunder.

Furthermore, motorcyclists will often have saddlebags affixed to either side of the motorcycle frame to carry items in them as they travel around.

As the cargo inside each of these storage areas is valuable to its owner, there is a need to prevent unauthorized access to these access points and as a results the above doors, compartments, boxes, containers, covers and bags are usually lockable.

The invention will be more particularly described herein with respect to doors on an enclosed van of a truck. However, the invention has general applicability as detailed above. The presence of such lockable doors brings with it a problem where each door requires its own key for moving its locking mechanism between its locked and unlocked conditions. When the vehicle has a number of lockable doors, the driver has to act on each of the locking mechanisms in order to open its relevant door. One example is where the transport/delivery truck may have eight (8) access doors into its rear enclosed van area, wherein behind each door is a bay holding different cargo relative to each other bay and the driver may need to unlock and open each of the eight doors in turn, until he finds the correct bay. For the driver to walk around the truck, unlocking and then relocking each door, comes at a time cost penalty, which is exacerbated when the doors do not have common locks and each requires a different key. If there are many keys, further time is spent by the driver trying multiple keys in a particular lock, until the correct one is found.

In addition, before the driver either leaves his vehicle or drives away, he must ensure that each door is locked. Thus, further time is wasted.

Further, when returning cargo to a bay in the transport vehicle, the driver may have to put the cargo down on the ground by the side of the vehicle and then find the appropriate key to insert into its relevant lock and then open the door to the desired bay. With the door open, the driver then needs to pick up the returned cargo, put it back into its bay and then close the bay door and relock it. If the driver is returning several different pieces of cargo, which are required to be located in and behind several different doors, more time is lost.

More particularly, if any of these events occurs at night, there is an even greater inconvenience to the driver who in addition may need to car a flashlight to help him find the relevant key.

In many instances, the type of locking arrangement found in the Prior Art has been of a type that accommodates a low security locking means and thus a simple door lock and latch may suffice in some situations. However, as the value of the cargo held in the storage bays increases, so must the standard and security of the door and its locking mechanism. The swing handle has found wide-spread acceptance as the door handle of choice on transport vehicles and the like, since it is able to be essentially flash-fitted to the relevant compartment on the vehicle and handles of this type are able to accommodate a high security locking paeans where required.

Most modern vehicles, particularly trucks and motor cars and even motorcycles, have central locking facilities, wherein through activation of a suitable actuator via a remote control device or via the vehicle's own key, the vehicle's lockable doors cat be individually in some cases or in most cases, all be locked and unlocked simultaneously.

By linking each door's locking mechanism to the vehicle's central locking system, some of the above problems can be overcome but others remain. However, where the locking mechanism employs a swing handle arrangement, which accommodates a high security lock, there is need for the integrity of the high security lock to be maintained as required.

It is an object of the present invention therefore to provide an improved locking arrangement. More particularly, the present invention provides a locking arrangement, which seeks to ameliorate the disadvantages of the prior art.

### SUMMARY OF THE INVENTION

The locking arrangement of the present invention comprises a lockable handle assembly having an independent locking mechanism, which mechanism cooperates with an engagement means operable by an actuator said actuator itself being operable by a vehicle's central locking system, wherein when the engagement means is placed in lockable contact with the locking mechanism of the handle assembly by the actuator, the locking arrangement is placed in a locked condition.

Preferably, the handle assembly comprises a swing handle and a supporting frame therefor where the swing handle supports the lockable locking mechanism, which mechanism comprises a movable pawl being separately movable relative to the locking mechanism between a locked and an unlocked position. The lockable contact between the engagement means and the pawl, more preferably a substantially outwardly extending pawl, occurs when the engagement means and pawl contact one another.

Preferably further, the supporting frame of the handle assembly has a frame chamber located therebeneath and into which the locking mechanism is receivable and the pawl is able to be moved into its locked position therein. More preferably, the engagement means comprises a tongue member adapted to at least partially overlie the pawl when the pawl is located therebeneath.

The frame chamber preferably has a slot therein through which the tongue member is able to protrude into the inside of the frame chamber, whereby the tongue member is movable within and/or along the slot between a first position where the tongue member is contactable by the substantially outwardly extending pawl rendering the locking arrangement locked and a second position where the tongue member is no longer contactable with the pawl thereby rendering the locking arrangement unlockable.

The engagement means is further more preferably directly or indirectly connected to the actuator whereupon when the actuator in response to a first signal from the central locking system moves to a first position, the engagement means correspondingly moves into a lockable contact position with the pawl; and whereupon when the actuator in response to a second signal from the central locking system moves to a second position, the engagement means is correspondingly moved to a position whereby there is no lockable contact with the pawl.

More preferably, the tongue member is mounted on or is connectable to a supporting body which body is coupled at one end to the actuator, wherein the other end of the supporting body cooperates with a guide member which assists in alignment, positioning and/or containment of the tongue member within the slot in the frame chamber. The tongue member further preferably comprises a guide means located therein or thereon to further assist in alignment, positioning and/or containment of the tongue member within the slot in the frame chamber.

Most preferably, movement of the actuator is electromagnetically actuated.

The present invention is also directed to a locking system comprising a plurality of access points for example doors, lids, tops, covers, hatches and/or the like wherein the or each access point/s is cooperable with at least an equal number of the locking arrangement/s of the invention, such that the locking arrangement's when in a locked condition prevent entry into or through the or each access point/s and when the locking arrangement/s is in an unlocked condition, it permits entry into or through the or each access point/s being rendered in the unlocked condition.

In a preferred form of the invention, one or more of the locked access points is unlockable while one or more other access points remain in the locked condition.

The scope of the present invention also extends to a method of reversibly locking via a locking arrangement at least one lockable vehicle access point, the vehicle having a central locking system, wherein the locking arrangement mountable on the access point comprises a handle assembly having an independently lockable locking mechanism and an engagement means operable by an actuator the actuator itself being operable by the central locking system wherein the method to lock the access point comprises activating the actuator by a first signal from the central looking system to bring the engagement means into contact with the locking mechanism of the handle assembly and thereby placing the locking arrangement and the access point on which it is mounted into a locked condition thereby preventing entry to or through the access point; and wherein the method to unlock the access point either comprises activating the actuator by a second signal from the central locking system to break the contact between the engagement means and the locking mechanism, thereby placing the locking arrangement and the access point in an unlocked condition, or alternatively, unlocking the independently lockable locking mechanism of the handle assembly to break the contact between the engagement means and the locking mechanism, thereby permitting entry to or through the access point. More preferably, the actuator is electromagnetically actuated.

Preferably, when the locking mechanism is not in contact with the engagement means, the handle of the handle assembly is not locked relative to the engagement means and is able to be moved to permit opening of the access point, such as a door or panel upon which it is located.

Preferred handle assemblies that can be used with the present invention are those described in Australian Provisional Specification Nos. 2004903770 or 2004904608 now PCT/AU2005/000999, The subject matter of these specifications are incorporated herein by way of reference.

The handle assembly of PCT/AU2005/000999 is particularly useful in that the preferred assembly of that specification concerns a swing handle assembly useful for high security applications in that it is capable of accommodating a high security locking mechanism. Where a high security application is not required, the high security locking mechanism can be replaced by a push-button locking mechanism of the type known in the Art. A swing handle and high security locking mechanism will be hereinafter described in relation to the present invention. The swing handle found to be most suitable for use on the above described doors, compartments, locks, containers, covers and bags, is a handle which can be substantially flush-mounted thereon and as a result one which does not protrude excessively from the device upon which it is mounted. The handle itself can preferably be substantially seated or contained within its supporting frame when the handle is not being used. When so seated or contained, its co-operating locking mechanism is able to be accommodated within the frames chamber that is located, and preferably hangs, underneath the supporting frame. The engagement means of the actuator is preferably able to pass/protrude into this chamber and releasably co-operate with the locking mechanism and thus the locking mechanism.

The actuator preferably further contains an actuation member that is controllable and preferably coupled to the central locking system of the vehicle for moving between a locked and unlocked condition. The actuation member can be of the type usually employed in a central locking system. A suitable actuation member is as shown in U.S. Pat. No. D340938.

The actuator can therefore be of the type where its engagement means is pneumatically, hydraulically, electromagnetically and/or mechanically actuated. Preferably, the actuator is of the same type as used elsewhere in the vehicle, but it and its mode of operation may be different therefrom.

In a preferred form, the actuator is electromagnetically actuated. Most central locking systems employ a receiver located on or within the vehicle whereby through activation of a portable transmitter by the vehicle's user, the receiver receives a signal or code. Due to the connection of the receiver to each actuator within or on the vehicle, a signal transmitted by the transmitter is received by the receiver, which relays at least one type of control input to the actuator. One control input is a lock signal and another input is an unlock signal.

The actuator can be of the type wherein upon receipt of a lock or unlock signal, the actuator's solenoid or motor is activated which in turn causes its working end to move forwardly upon receiving a lock signal and backwardly upon receiving an unlock signal or vice versa.

To the working end of the actuation member, the engagement means is preferably located and releasably mountable thereon. The engagement means may be integral with the working end or releasably attachable thereto. Preferably, the engagement means is in the form of a tongue member, which is securable to the working end. The tongue member in one form may be a substantially flat piece of suitable material. Where the working end has a coupling nose member, it is preferably of a substantially helmet or bell shape having an anchoring means therein. Preferably, the anchoring means is an opening adapted to receive a detachable fastening means for securing the engagement means to the actuation member via the nose member.

The tongue member can be of a substantially T-shaped configuration such as for example a flanges The T-configuration being made up of a cross-piece and a stem-piece.

The tongue member can also be of a substantially Z-shaped section, having a top flanged portion, a central web portion and a bottom flange portion. The central web portion is preferably substantially perpendicular to both its adjoining top and bottom flange portions. Each portion may be of the same or different length and/or thickness as one or more of the other. In a preferred form, the web portion is usually of greater general size in both length and thickness relative to the top and bottom portions.

The top portion preferably has the form of an open channel-shaped member to enable the top portion to straddle and at least partially accommodate the nose member of the actuator. In addition, the top portion may also contain its own anchoring receiving opening therein to aid in releasably affixing the anchoring means and thus releasably holding the nose member in contact with the tongue member, so that movement of the nose member causes movement of the tongue member.

To the top portion, a guide means is preferably located thereon or therein to assist in aligning the travel of the tongue member relative to the actuation member. Preferably, the actuator is mountable to a support frame such as a bracket which bracket also contains an alignment means therein to co-operate with the guide means. This alignment means can also act as a restraining means such that it can function to determine the extent of forward and backward travel of the tongue and coupled nose members relative to the substantial remainder of the actuator, which is stationary.

The bottom portion of the tongue member is preferably parallel but extends away from the web portion in the opposite direction to the top portion. At least a part of the tongue member being adapted to be receivable within and pass through and/or move along a recess or slot in the frame chamber of the supporting frame of the handle arrangement. Preferably, the slot is formed in only one sidewall of the frame chamber. In this way, a part of the tongue member is able to protrude into the inside of the frame chamber when the actuator is placed in a locked condition. When the actuator is again acted upon, it can resume an unlocked condition and either that portion of the tongue member that protruded into the frame chamber is substantially withdrawn away from the inside of the chamber so that it preferably no longer protrudes into the internal space of the frame chamber. Alternatively that portion is moved along the slot of the frame chamber to a position wherein that portion no longer interferes with a lock mechanism when located within the frame chamber.

The independently lockable locking mechanism can be of any typical type as known and used in the Art. In a preferred aspect, the locking mechanism comprises a locking menus, which can include a lock cylinder or barrel and key arrangement. In another preferred form die locking mechanism is of the push-button type comprising a lock cylinder or barrel with an outwardly urged button connected to a lock means such as a lock pawl which is substantially retracted into the lock cylinder upon application of pressure upon the biased button. Preferably, the locking mechanism is of the high security barrel type. The one form, the locking mechanism may comprise a key-receiving end in the lock cylinder and a locking bolt end, wherein the locking bolt end has a lock pawl. By rotating a key in the key-receiving end, the lock pawl not in a locked position can be placed in that locked position. By rotating the key in an opposite manner or to a second position, the locked lock pawl can be rendered into an unlocked position. The lock pawl preferably co-operates with the engagement means to enable the handle member of the handle assembly, preferably carrying the locking mechanism, to be locked to its supporting frame. Preferably, when the tongue member protrudes into the internal space of or is suitably positioned in the frame's chamber, the lock pawl releasably contacts the tongue member to thereby lock the handle member by substantially preventing the handle assembly from being lifted out of its surrounding supporting frame and thus being unable to be rotated, i.e. be used to open the door to which the assembly is mounted.

A preferred locking mechanism is as described in PCT/AU2005/000999. The handle assembly is preferably located upon the door, lid, cover etc. that is to be opened, which door, lid, cover, etc. is movable i.e. hinged, pivotable or slidable relative to the remainder of the vehicle body or the compartment which is to be locked or unlocked. Thus, for a door entry into the rear-enclosed van, the door preferably holds the handle assembly and its locking mechanism while the actuator and engagement means are mounted to the van body. Alternatively, the handle assembly and locking mechanism can be positioned on the vehicles van's body while the actuator and engagement are fitted on to the door. In another form the handle assembly, its locking mechanism the actuator and engagement means are all mountable on the same access point.

With the handle member positioned or sitting in its supporting frame, part of the locking mechanism, namely its cylinder barrel and its lock pawl are preferably at least partially accommodated within that frame's chamber. When so positioned, the user is then able to operate the locking mechanism, whereby the lock pawl is caused to swing out (extend outwardly) of alignment to the remainder of the mechanism by approximately 30° to 45° (relative to the walls of the supporting frame) to take up its locked position. With the lock pawl in this situation, should the tongue member sufficiently protrude into or be positioned into the chamber whereby the lock pawl is contacted by, preferably retained under or by the tongue member, the locking mechanism and thus its handle member to which it is secured is substantially prevented from being able to be lifted out of its supporting frame and thus prevented from being moved.

If the tongue member is retracted from protruding into or is re-positioned within the chamber, where it no longer contacts, preferably retains the lock pawl thereunder, the locking mechanism and thus its handle member to which it is secured is abled to be lifted out of the supporting frame and can be moved, thereby permitting the access point to be opened.

Accordingly, through causing the tongue member to co-operate with the lock pawl, the locking arrangement can be placed in a locked or unlocked condition.

The tongue member can be of a channel-type member wherein the lock pawl can be captured and contacted in the open channel space and thus is sandwiched between the channel web members. This embodiment however requires greater tolerances between the various components so that they do not inadvertently interfere with one another.

The tongue member can be of a substantially T-shaped section comprising a cross-piece and a stem-piece. Preferably, the cross and stem-piece are integral to one another and formed from a single flange member and are of substantially the same thickness. Alternatively, the stern-piece may be of a reduced thickness relative to the cross-piece. In its various forms the T-shaped section can be mountable to or on a support body which acts to support the stem-piece. The stem-piece being adapted to be receivable within and/or, travel along the recess or slot in the frame chamber.

The cross-piece which may be supported by or is part of the support body may have a guide means preferably a ball-catch member located therein or thereon to assist in aligning the stem-piece of the tongue member relative to the actuator. The guide means being adapted to cooperate with a retaining member having means therein which will engage with the guide means to maintain the tongue member within the frame chamber's recess or slot. The retaining means preferably comprising two spaced apart notches within the support body wherein through activation of the vehicle's central locking system, the actuator and, its working end, moves the guide means to cooperate with the notch distal away from the actuator. In this way the tongue member has been caused to travel along the recess or slot to a position wherein the stem-piece overlies or can contact the locked pawl. Upon again actuating the actuator but this time in the opposite direction thereto whereby the guide means is caused to be removed from the distal notch and retract back to and engage with the proximate notch, the stem-piece will no longer overlie or contact the locked pawl, Depending upon the location of the locked pawl within the frame chamber the above operation can act in reverse whereby extension of the actuator causes the stem-piece not to overlie the pawl while retraction of the actuator exposes the locked pawl for possible contact with the stem-piece.

With the assembly of the present invention, the locking mechanism can always be maintained in a locked position and the key permanently removed. In this way with the lock pawl in the active locked position where it extends outwardly from the mechanism simply by activating the tongue member via by the actuator, one is able to place the arrangement in a locked or unlocked condition; By causing the tongue member to protrude into or be placed in the chamber it will preferably contact and/or overlie and retain the lock pawl located thereunder. By removing the tongue member out of contact or so it no longer overlays the pawl, the lock pawl (even though it itself is locked) is free to be lifted out of the chamber.

Accordingly, the user is able to set all of the individual door's locking mechanisms into the active locked position and is able to remove each individual lock's key then through activation of the individual actuators, their relevant tongue members can slide into position into or within each chamber and thus all access points are simultaneously locked. Using the central locking system to then actuate the actuator in the opposite direction causes each tongue member to retract or move out of lockable contact, then enabling each handle to be lifted and rotated. The activation signals cm be selected to open any one or more of doors at once.

With the tongue member in its lockable contact position within its chamber, the user can still manually open a selected access point by inserting its relevant key and by turning this key, its relevant lock pawl is caused to be rotated out of engagement with its associated tongue member and that selected access point is then able to be opened while all remaining access points are maintained in a locked condition.

### DESCRIPTION OF THE DRAWINGS

Other features and advantages of one or more preferred embodiments of the present invention will be readily apparent to one of ordinary skill hi the art from the following written description with reference to, ad used in conjunction with, the accompanying drawings, in which;

FIG. 1 is a perspective front view of one form of the locking arrangement of the present invention;

FIG. 2 is a perspective rear view of the invention of FIG. 1;

FIG. 3 is another perspective rear view of the invention of FIG. 1;

FIG. 4 is a plan view of FIG. 2;

FIG. 5 is a side view of the invention of FIG. 1;

FIG. 6 is a top view taken in the direction of arrow A of FIG. 1;

FIG. 7 is a side view of one form of the tongue member;

FIG. 8 is a front-on view taken in the direction of arrow C of FIG. 7;

FIG. 8A is an underside view taken in the direction of arrow D of FIG. 7;

FIG. 9 is a part-sectional view through B-B of FIG. 5;

FIG. 10 is the nose member of the actuator;

FIG. 11 is a plan view of the actuator's supporting frame;

FIG. 11A is a side view taken in the direction of the arrow E of FIG. 11;

FIG. 12 is front view of one form of the invention wherein the normally hidden actuator and relevant parts of the locking mechanism are shown in ghosting, as they are not seen in an in-use situation;

FIG. 13 is a partial cross-sectional view along the line F-F of FIG. 12;

FIG. 14 is a cross-section view of a part of the female member of one form of the retaining means;

FIG. 15 is a perspective front view of a handle assembly having a push-button action locking mechanism therein;

FIG. 16 is a front view of the handle assembly of FIG. 15;

FIG. 17 is a cross-sectional view along line G-G of FIG. 16;

FIG. 18 is a front view of the handle assembly having a key-action locking mechanism therein;

FIG. 19 is a cross-sectional view along line H-H of FIG. 18;

FIG. 20 is a front view of another form of the invention wherein part of the engagement means as normally hidden under the handle assembly is shown in ghosting, and the engagement means is not in contact with the locking mechanism;

FIG. 21 is a front view of the invention as shown in FIG. 20 however the engagement means is in a contact position with/for the locking mechanism;

FIG. 22 is a perspective view of the handle assembly of FIG. 15 when the handle has been removed from the supporting frame and moved anti-clockwise;

FIG. 23 is a perspective view of a handle assembly wherein the handle has been removed from its supporting frame, rotated anti-clockwise and wherein the locking mechanism is in an unlocked position with the engagement means which means has also been moved to an unlocked condition;

FIG. 24a is an exploded perspective view of another form of the tongue member;

FIG. 24b is a perspective view of the tongue member of FIG. 24a connected to a part of the actuator;

FIG. 24c is a perspective underside view taken in the direction of arrow I of FIG. 24b;

FIG. 25 is a partial view of the engagement means in its contact position connected to the working end of the actuator, with that part of the ball-catch and a fastener coupling the engagement means, and actuator which are hidden are shown in ghosting and another form of the retaining means shown in cross-section;

FIG. 26 is the same view of the engagement means, working end, actuator retaining means, ball-catch and fastener, but wherein the engagement means is in its non-contact position;

FIG. 27 is a perspective view of an open tool box with one form of the locking arrangement of the invention;

FIG. 28 is a partial view of that part of the locking arrangement of the invention as seen taken in the direction of arrow J of FIG. 27 when the arrangement is in a locked condition;

FIG. 29 is a partial view of that part of the locking arrangement of the invention as seen taken in the direction of the arrow T of FIG. 27 when the arrangement is in an unlocked condition;

FIG. 30a is a top view of a keyed-locking mechanism with its lock pawl in the locked position;

FIG. 30b is a side view taken in the direction of arrow M of FIG. 30a;

FIG. 30c is a side view taken in the direction of arrow N of FIG. 30a;

FIG. 31a is a top view of a keyed push-button locking mechanism with its lock pawl in the locked position;

FIG. 31b is a side view taken in the direction of arrow O of FIG. 31a;

FIG. 31c is a side view taken in the direction of arrow S of FIG. 31a;

FIG. 32a is a front-on view of one form of the retaining means with passageways therethrough shown in ghosting;

FIG. 32b is a side-view of FIG. 32a where the distal and proximate notches are shown in ghosting; and

FIG. 32c is an end-on view of FIG. 32a where the notches and a passageway therethrough is shown in ghosting.

### DETAILED DESCRIPTION OF THE PREFERRED EMBODIMENT

Referring to all the drawings wherein like reference numerals designate like or corresponding parts throughout the several views, the locking arrangement 10 includes a locking mechanism 30 releasably securable to a supporting plate 100, which plate in an in-use situation is preferably the access point for example door member, lid or the like which is to be placed in a locked condition.

The arrangement 10 also includes an actuator 60, which is adapted to co-operate with the locking mechanism 30 to hold the door member in a locked or unlocked condition. The actuator 60 is connectable to and operable with the vehicle's general central locking system.

The actuator 60 comprises an engagement means 61, which is preferably in the form of a tongue member 62. Preferably, the tongue member 62 as illustrated is of a substantially Z-shaped configuration and is positioned at one end, namely the working end 68 of the actuator 60. In this form, the tongue member 62 has a central web portion 63 with opposed top 64 and bottom 65 web portions extending substantially perpendicular therefrom.

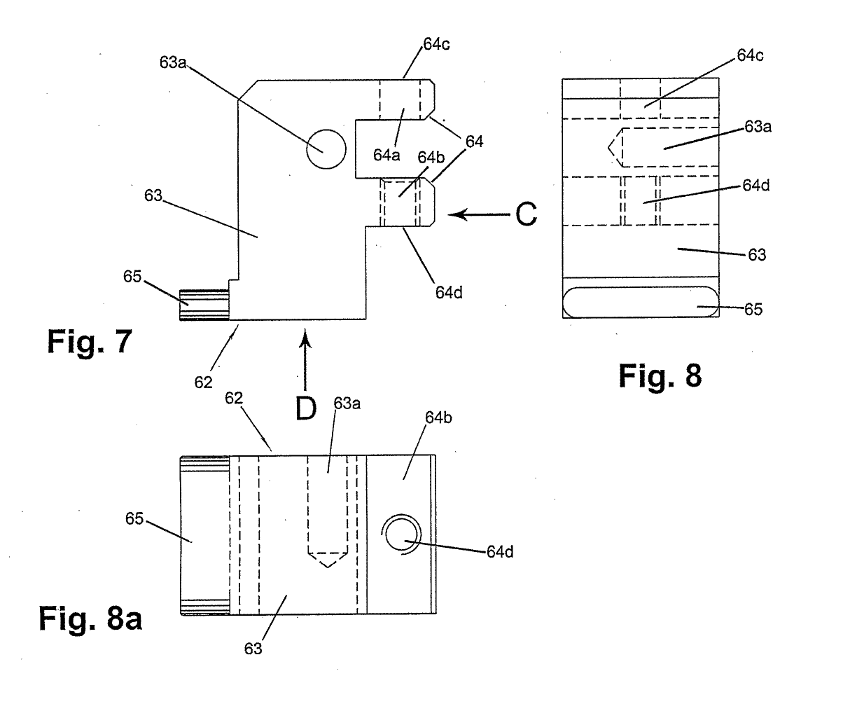

The top web portion 64 is itself preferably in the form of an open-channel-sectioned member as shown in FIG. 7 with outwardly extending flanges 64a and 64b.

The actuator 60 as shown is of the electromagnetic type, as used in the alt of vehicle central locking devices. The actuator's internal operator mean(s) (not shown) is/are accommodated within a housing 67. A solenoid/motor 66 is usually connectable to the vehicle central locking system by wiring. However, should the actuator 60 be pneumatically, hydraulically and/or mechanically actuated, suitable linkages other than the solenoid/motor 66 as known in the art can be used to connect and act upon the actuator 60.

To the working end 68 of the actuator 60, there is provided a coupling nose member 69 (refer to FIG. 10). The nose member 69 extends from the bellows 70 of the actuator 60. The nose member 69 can couple with the tongue member 62. Preferably, the nose member 69 is locatable between opposed flanges 64a and 64b of top web portion 64 of the tongue member 62. The nose member 69 is preferably releasably securable to the top web portion 64 by means of a fastening means 71 such as a threaded screw or bolt, which can pass through aligned openings 64c and 64d in flanges 64a and 64b respectively of the top web portion 64 with an opening 69a of nose member 69 positioned therebetween.

Through activation of the actuator 60 via signals received by the solenoid/motor 66, the tongue member 62 (when coupled to the actuator 60 via its nose member 69 connection) is able to move in the direction shown by arrow L, resulting in the overall length of the actuator 60 being increased beyond its normal state and length. Upon receiving a second signal, the solenoid/motor 66 can move the connected tongue member 62 in the opposite direction as shown by arrow U, whereby the overall length of the actuator 60 returns to its normal state and length.

For the present purposes, when the tongue member 62 is moved in the direction of arrow L, the actuator 60 is placed in a locked condition. When the actuator 60 is caused to move in the direction of arrow U, the actuator 60 can be placed in an unlocked condition.

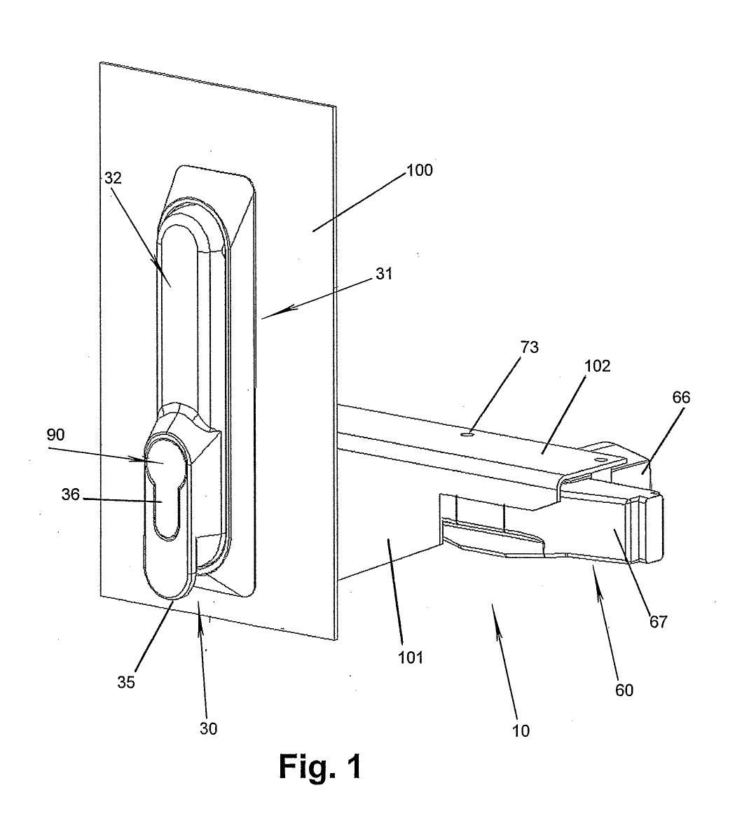

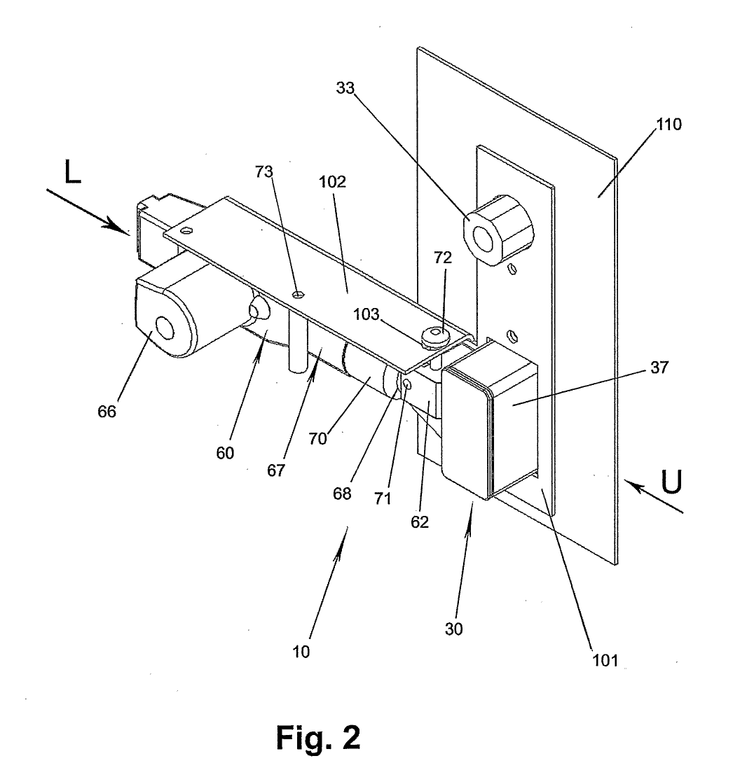

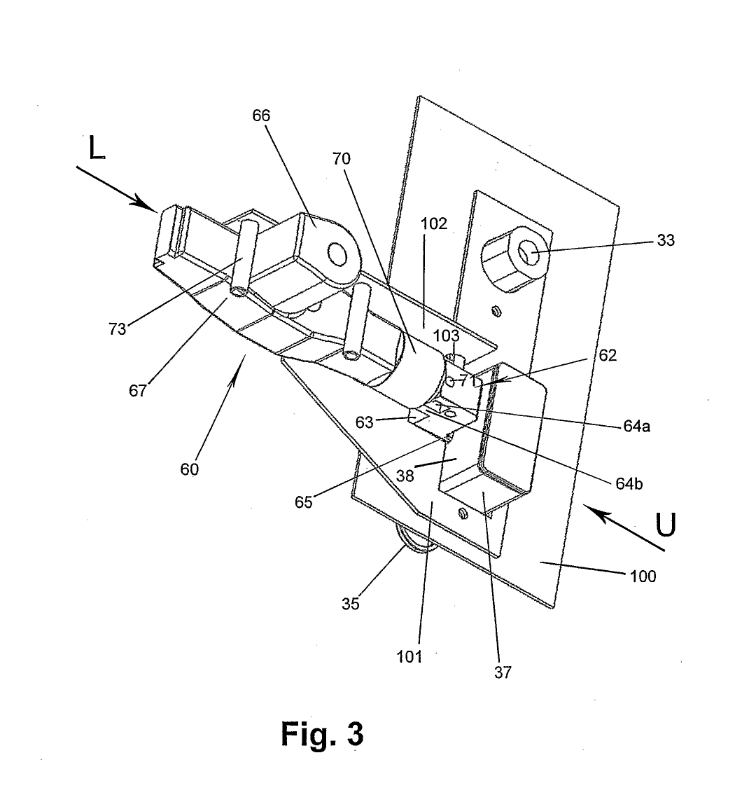

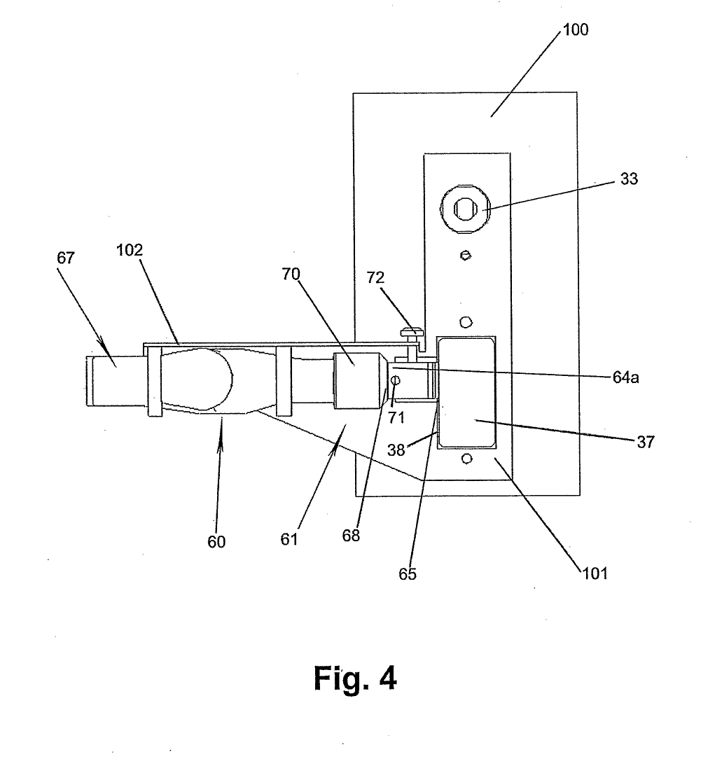

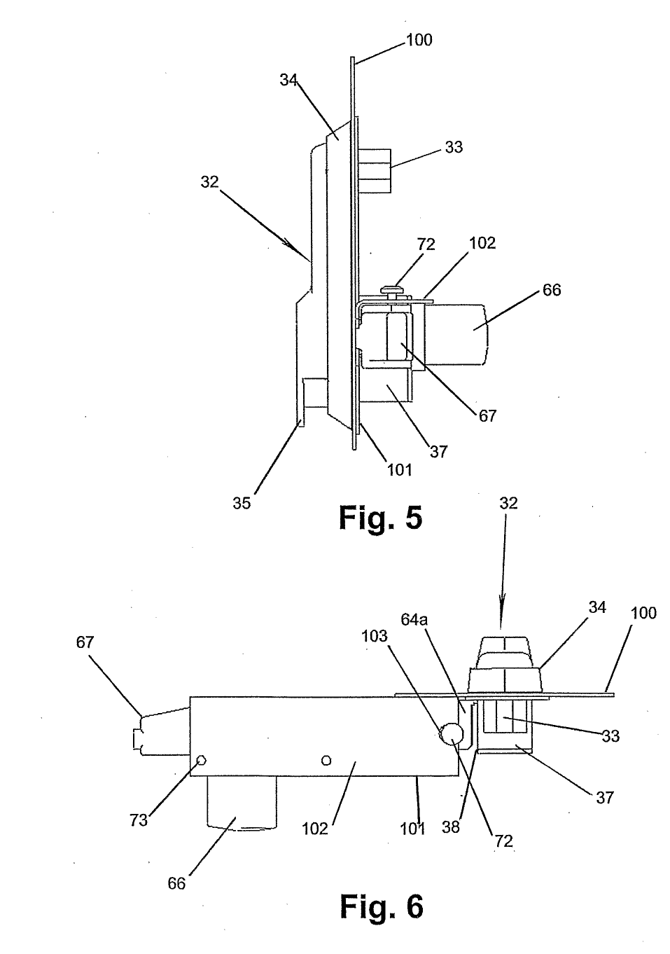

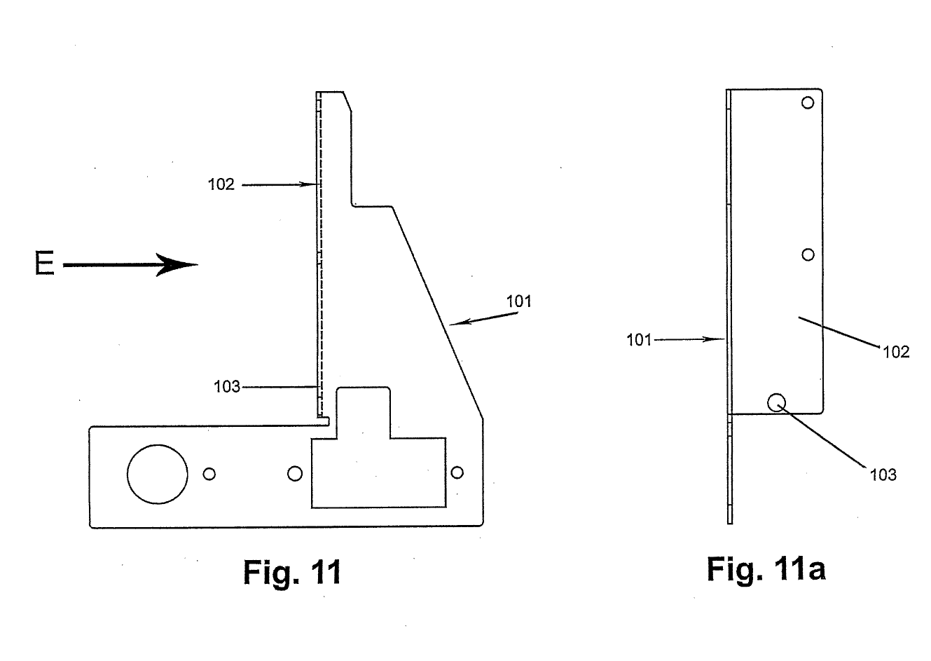

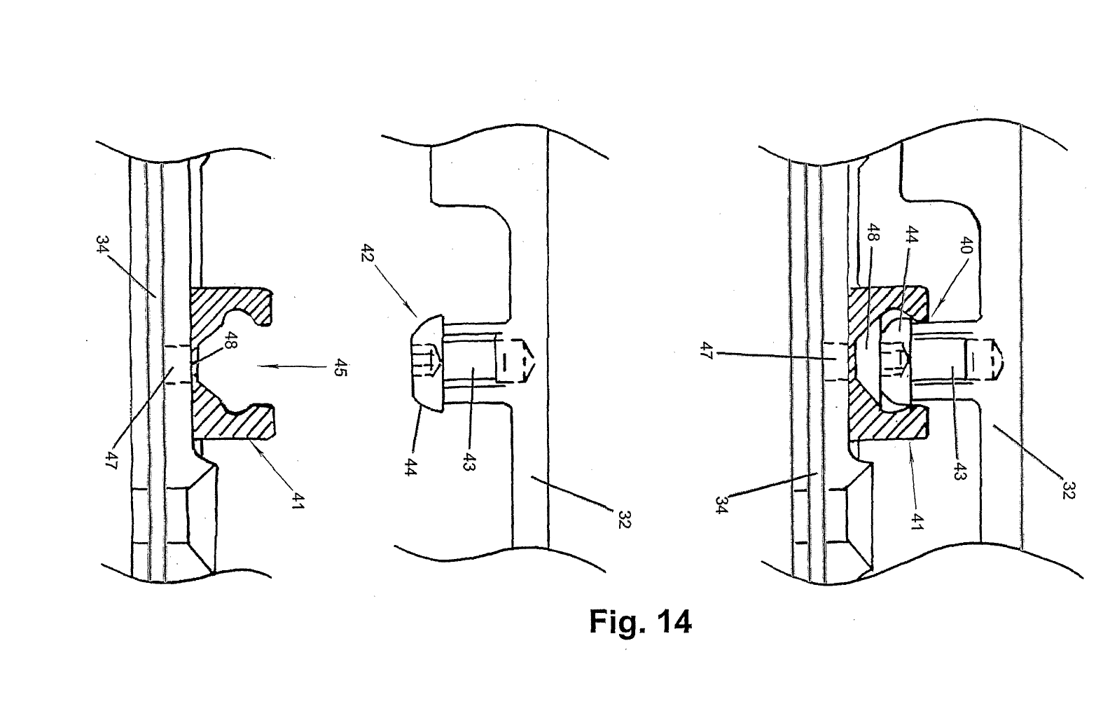

The actuator 60 can be separate from locking mechanism 30 and as such, it can be separately securable to supporting plate, door, lid etc. 100. In addition, to assist in correctly aligning the actuator 60 relative to the locking mechanism 30 as shown in FIGS. 1 to 14, the actuator 60 is preferably supported by its own supporting frame 101, which in turn is releasably mountable to supporting plate 100. Supporting frame 101 also provides some protection to the otherwise exposed housing 67 and its contents of the actuator 60. The supporting frame 101 is releasably securable to the door of the vehicle or lid of the compartment.

To an upper flange 102 of the actuator's supporting frame 101 there may be provided an alignment means 103, which may co-act with a complimentary guide means in the form of a threaded fastener 72 locatable within or on the tongue member 62. The threaded fastener 72 cooperates with a recess 63a positioned in central web portion 63 of the tongue member 62. The alignment means 103 can be in the form of a slot, the diameter or shape thereof can be used to limit the extent of movement of the actuator 60 via threaded fastener 72 in the direction of either of arrows L or U. Ea this way therefore, the extent that the tongue member 62, to which the threaded fastener 72 is secured, can protrude from the remainder of actuator 60, which is essentially held in position, can be pre-set. Securing means 73, preferably treaded fasteners, can be provided for fixing the actuator to its supporting frame 100.

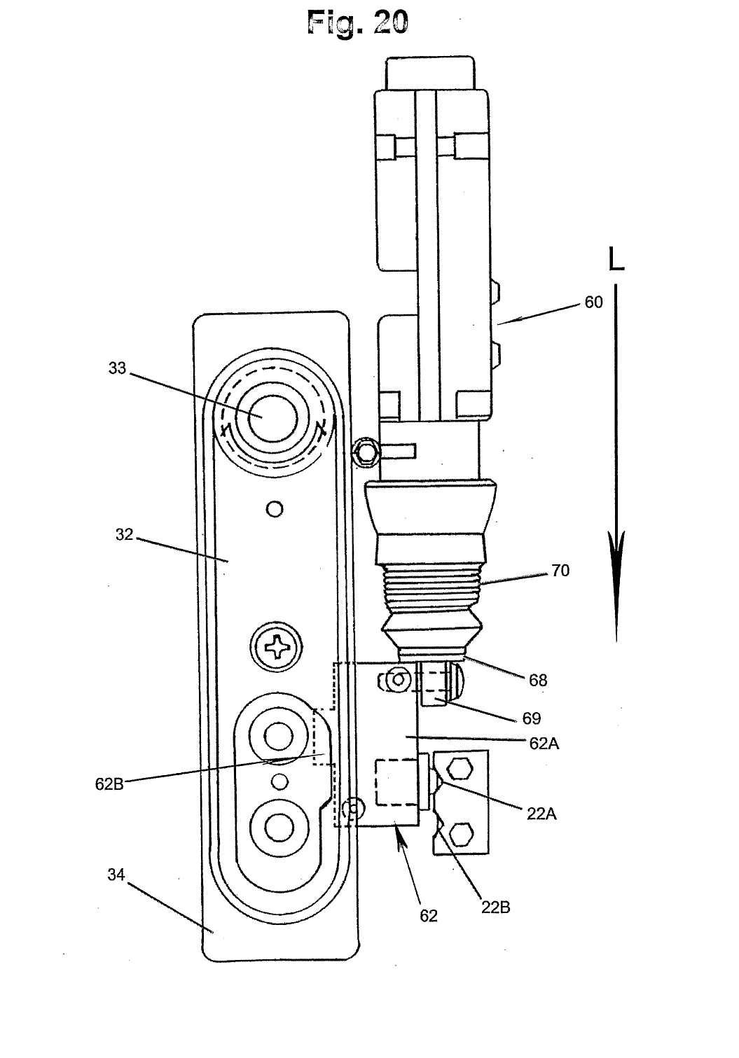

The actuator 60 of FIGS. 20, 21 and 27 to 29 ran bc mounted directly onto the supporting plate, door, lid etc. 100. In place of a supporting frame 101 as shown in FIGS. 1-14, which frame assisted in the alignment of the tongue member 60 relative to the actuator, there may be provided a retaining member 20. The retaining member 20 also acts to limit the extent of movement of the actuator 60 and the tongue member 62 when operating therewith in the direction of either of arrows L or U. Accordingly, the retaining member 20 can determine the extent that the tongue member 62 can protrude from the remainder of the secured actuator 60.

The retaining member 20 and catch means 56 may operate to together form a retaining means for the tongue member 62. The retaining member 20 is preferably of a substantially solid construction and can be of any particular shape provided it is able to cooperate with the tongue member 62 directly or via its support body 50 when the tongue member 62 is secured thereto. A substantially rectangular solid block construction is preferred for the retaining member 20. The bloc having two sufficiently spaced apart notches/bores 22A and 22B therein its top surface 21. The notches/bores 22A and 223 having a generally counter-sunken configuration with a substantially circular circumference, the outside diameters of which are sufficient to receive or at least partially receive the or part of the ball 56A of the catch means 56 therein.

The retaining member 20 can be releasably fixed to its supporting plate, door, lid etc. 100 or even supporting frame 101 if required by way of fastening means 71 which can be screwed through passages 23 which pass through the side walls 24A and 24B of the retaining member 20.

The locking mechanism 30 includes a handle assembly 31 preferably a swing handle assembly as described in Australian Provisional Specification No. 2004903710 or 2004904608 which are now PCT/AU20051000999. The swing handle 32 itself being pivotal about and relative to attachment point 33. The swing handle 32 is partially receivable within its own supporting frame 34, which thereby essentially permits substantial flush-fitting of the handle assembly onto its supporting plate 100 where the plate may be a door, lid or like to which the assembly is mounted. The swing handle 32, by means of a lifting means 35 which can extend beyond the end of frame 34 permitting the user to hold that free-end of the swing handle 32, can be lifted out of engagement with the frame 34. When the swing handle 32 is lifted free from frame 34, it is then able to pivot about attachment point 33, thereby permitting the handle 32 to be rotated if required.

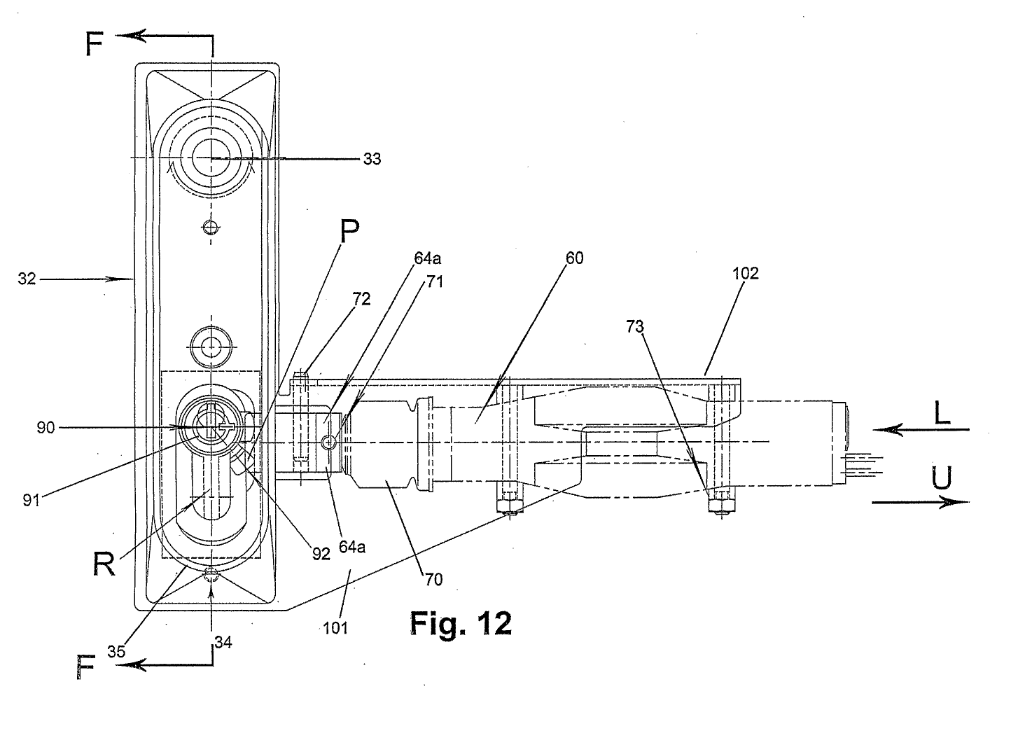

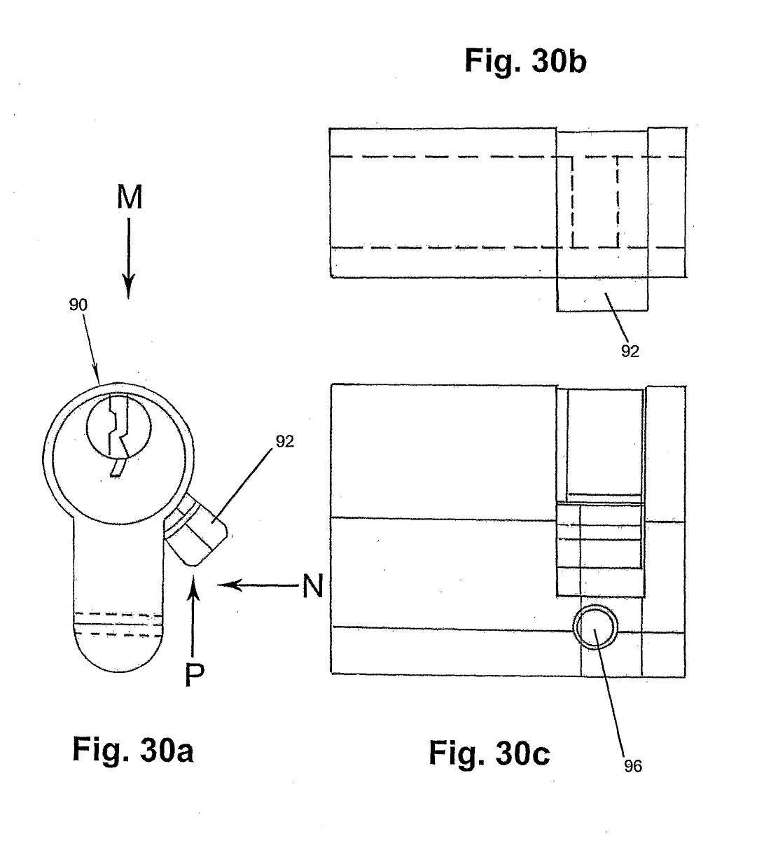

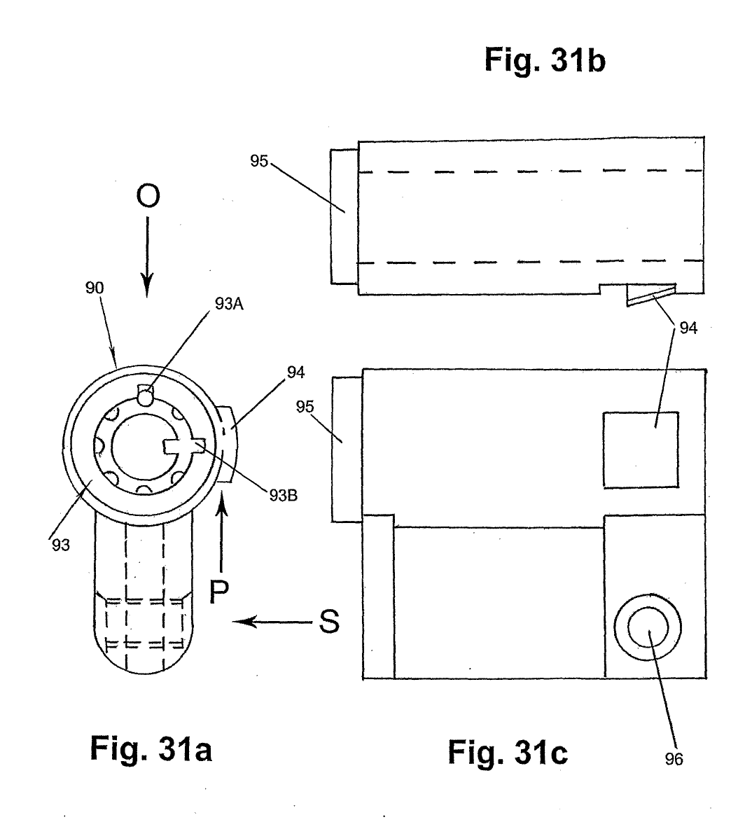

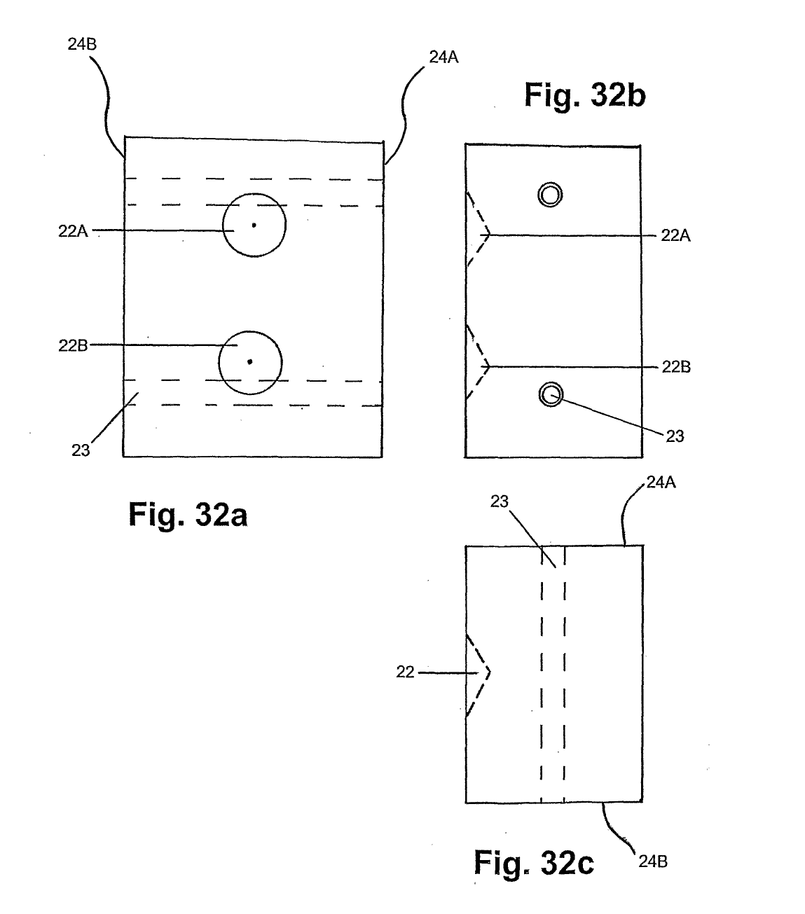

A suitable locking mechanism 90 can be located in opening 36 of the handle. Preferably, the locking mechanism 90 is of a high security type and comprises a keyed cylinder/barrel 91 and associated tack pawl 92, whereby the lock pawl 92 can be acted upon to render the locking mechanism 90 into a locked or unlocked condition. In FIGS. 12, 30A and 30B, the lock pawl of 2 and in FIGS. 31A and 31B, the lock pawl 94 are all shown in a locked condition at position P, whereas if the lock pawl 92 were at position R, it would be in all unlocked condition.

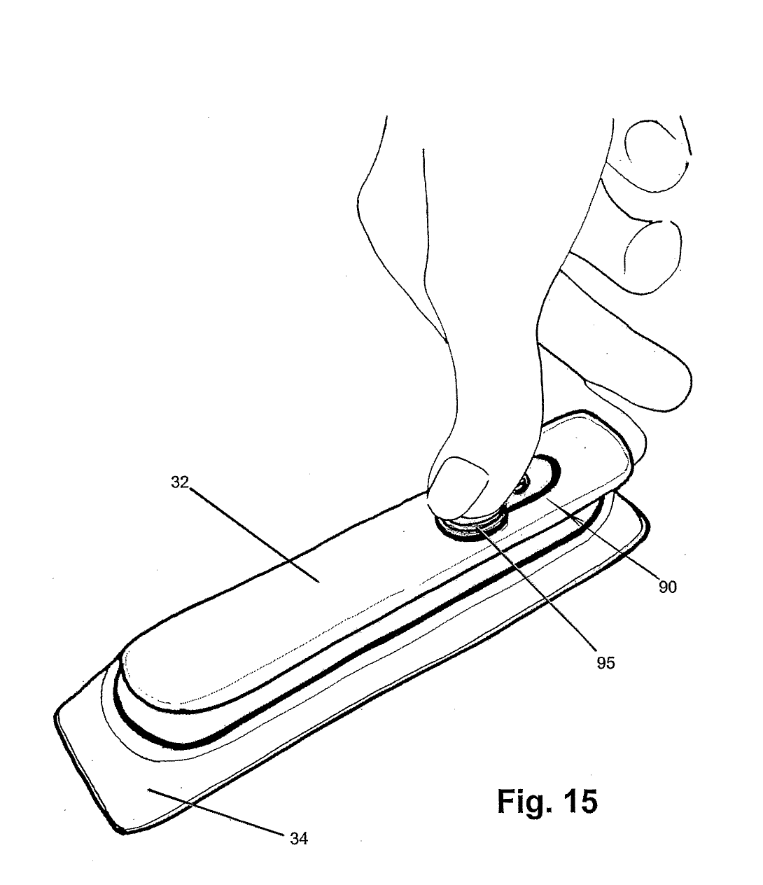

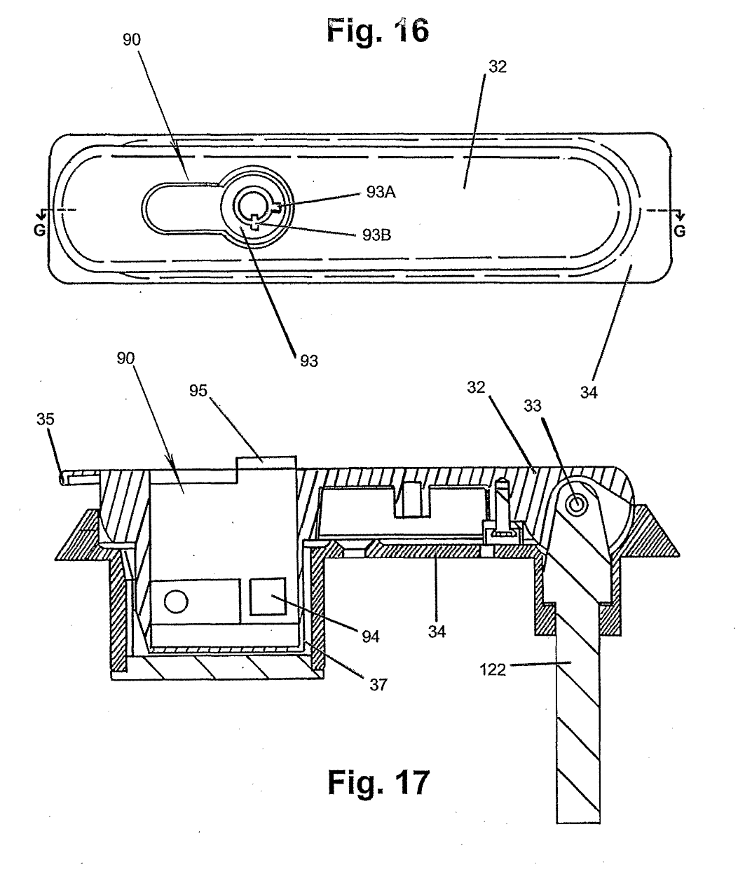

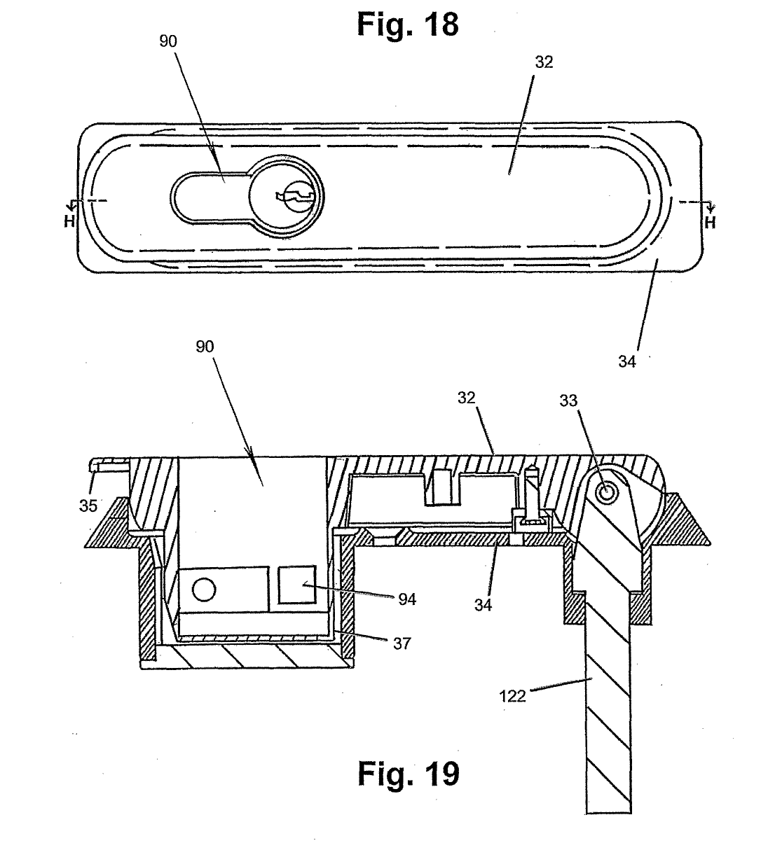

The locking mechanism 90 may also be of the keyed push button typo 93 with an associated pawl 94 as shown in FIGS. 31A, 31B and 31C. The push button type may sit proud of the upper surface of the swing handle 32 as illustrated in FIGS. 15, 17, 31B and 31C. The push button type 93 may comprise a restrained button 95 within its cylinder which button is biased to sit slightly proud of its surrounding surface as seen illustrated in FIG. 15. Through the application of applied pressure, usually by using ones' thumb, the button 95 is caused to move inward and against the bias and as a result, it triggers movement of its associated pawl 94 to move inward towards the interior of the surrounding lock body 97 in which the pawl is hinged. Thus pawl 94 retracts. The push button type 93 of locking mechanism 90 can also be key-locked which key adapted to cooperate with notches 93A and 93B. Opening 96 within the lock body 97 is adapted to receive a fastener means 71 to assist and holding and seating the locking means 90 within the locking mechanism support member 97 which support member 97 is adapted to support and hold the locking mechanism 90 to the swing handle 32.

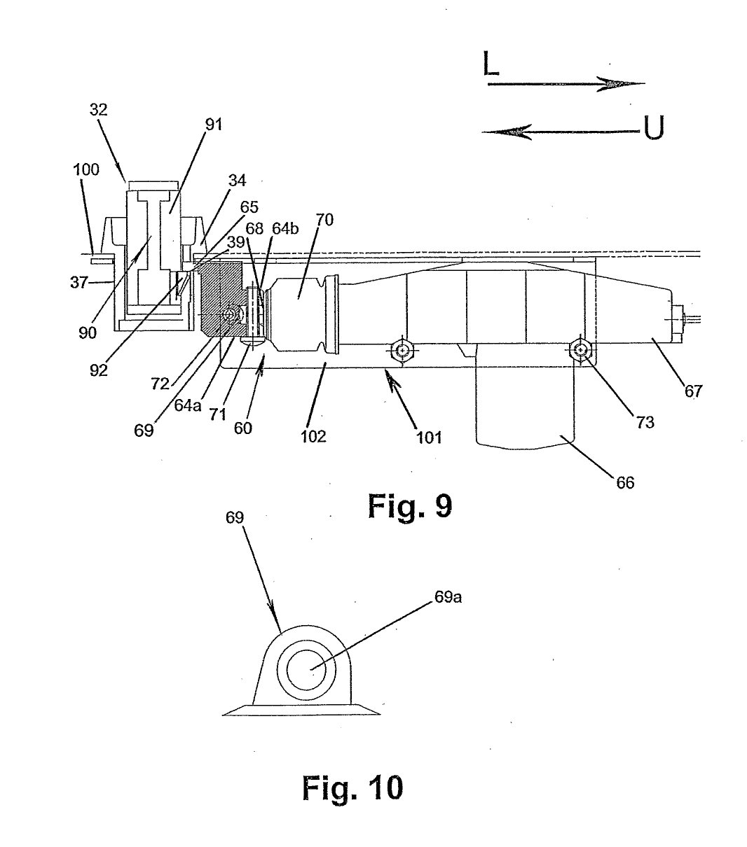

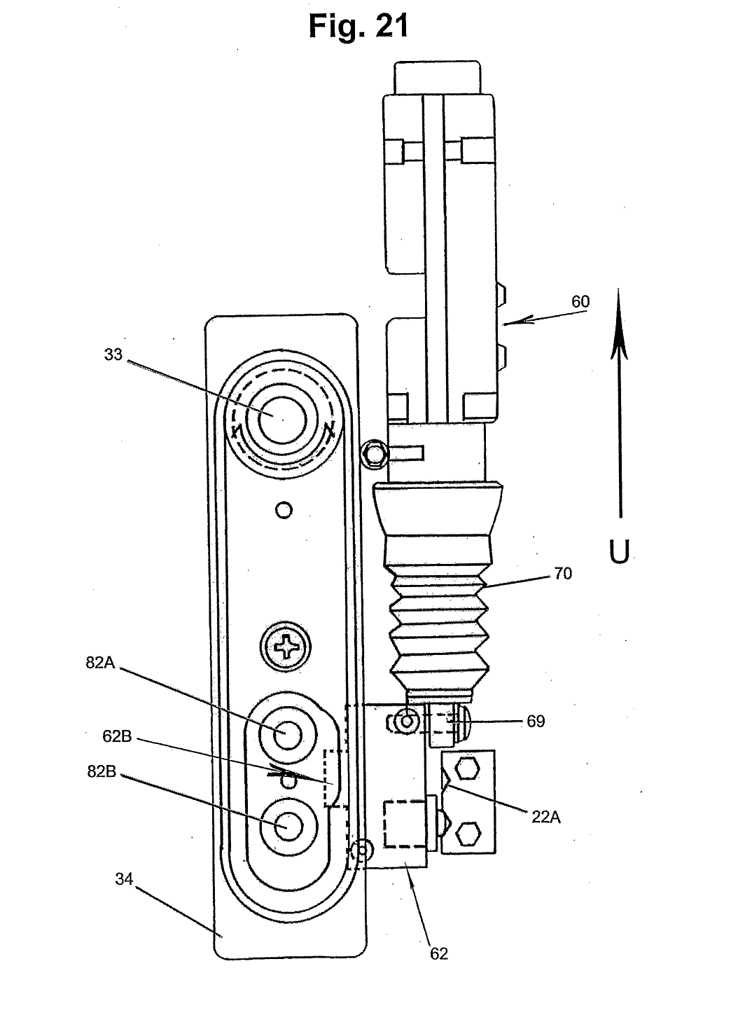

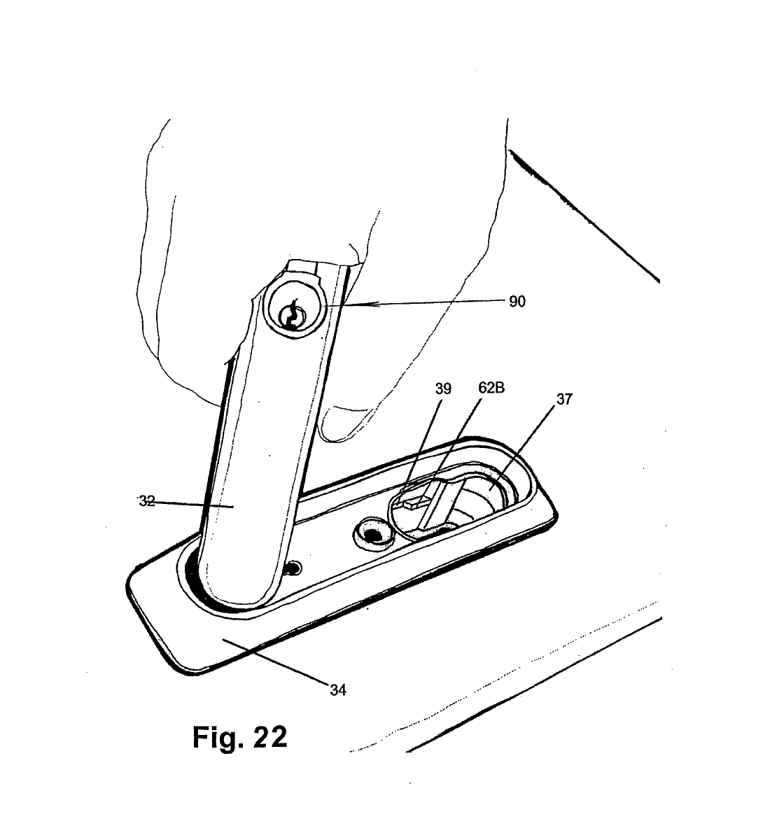

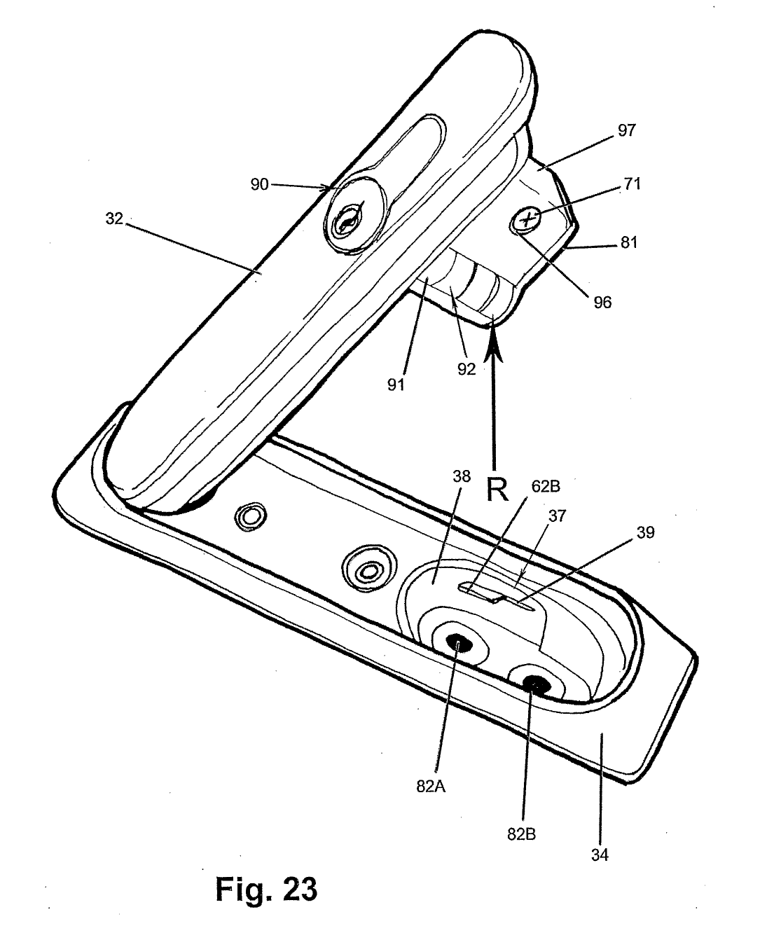

The frame 34 includes a chamber or well 37 located thereunder and into which at least part of the locking mechanism 90, most preferably at least the lock pawl 92 or 94 can be accommodated. In the embodiment shown in the Figures, the chamber 37 is a substantially enclosed box. Into the sidewall 38 of the chamber 37, which is nearest to tongue member 62, there is provided a chamber recess or slot 39 as shown in FIGS. 1 to 14 chamber recess or slot 39 is adapted to receive therein at least part of the bottom web portion 65 of the tongue member 62. The bottom web portion 65 can be suitably shaped of configured to permit easy access to and co-operation with the chamber slot 39. When the tongue member 62 is moved in the direction of the L arrow the bottom web portion 65 is able to pass through chamber slot 39 and thereby protrude into the inside of the enclosed chamber 37. In this situation, as shown in FIG. 9, when the lock pawl 92 is in the locked condition at position P and the actuator 60 has moved in the direction of arrow L, part of the bottom web portion 65 has moved into slot 39 of chamber 37 thereby protruding into the inside of chamber 37. As shown in FIGS. 22 and 23 the chamber recess or slot 39 is adapted to receive therein at least part of the stem-piece 62B of the tongue member 62. The stem-piece 62B can be suitably shaped or configured to permit easy access to and for movable cooperation with the chamber slot 39. The stem-piece may if also desired always or partially protrude into the inside of chamber 37 as shown in FIGS. 20 to 23 the situation shown in FIGS. 20 and 23 the stem-piece 62B is located at one end of the chamber slot 39 which end is nearest the attachment point 33 of the swing handle 32. In FIGS. 21 and 22 the stem-piece 62B is positioned further away from the attachment point 33 of the swing handle 32 and as such is as substantially located towards the other end of the chamber slot 39.

With the stein piece 62B as shown in FIGS. 21 and 22 when lock pawl 92 or 94 is in the locked condition at position P where the actuator has moved in direction L, the stem-piece 6213 has been moved along chamber slot 39 to the position as shown in FIG. 21 where the stem-piece and pawl are in lockable contact with the result that the locking arrangement is in a locked condition.

The lock pawl 92 or 94 because it now lies underneath and is held by the protruding bottom web portion 65 of FIGS. 1 to 14 or stem-piece 62B of the other Figures and in this scenario, the swing handle 32 is unable to be lifted out of its supporting frame 34. As a result of the swing handle 32 not being able to be operated, the handle is placed in a-locked condition.

To enable the swing handle 32 to be lifted out of its supporting frame 34, the lock pawl 92 or 94 needs to be moved out from under the overlying web portion 65 of FIGS. 1 to 14 or stem-piece 61B. This can be achieved in one of two different ways. The first way is to cause the lock pawl 92 or 94 to be moved from its locked position P to its unlocked position R. In this way, the bottom web portion 65 nor the stem-piece 62B are able to hold the lock pawl 92 or 94 thereunder or to hinder the lifting of the handle assembly 32 out of its supporting frame 34.

The alternative approach is to leave the lock pawl 92 or 94 in its locked position P and then remove the bottom web portion 65 of FIGS. 1 to 14 of stem-piece 62B from hindering the lock pawl 92 or 94. For the embodiment of FIGS. 1 to 14, by retracting the bottom web portion 65 in the direction of the U arrow so that it does not hinder the lock pawl 92 from being raised out of chamber 37, or for the embodiment of FIG. 21 by moving the stem-piece 62B from its position as shown in FIG. 21 to its location as shown in FIG. 20, the swing handle 32 can be lifted out of its supporting frame 34.

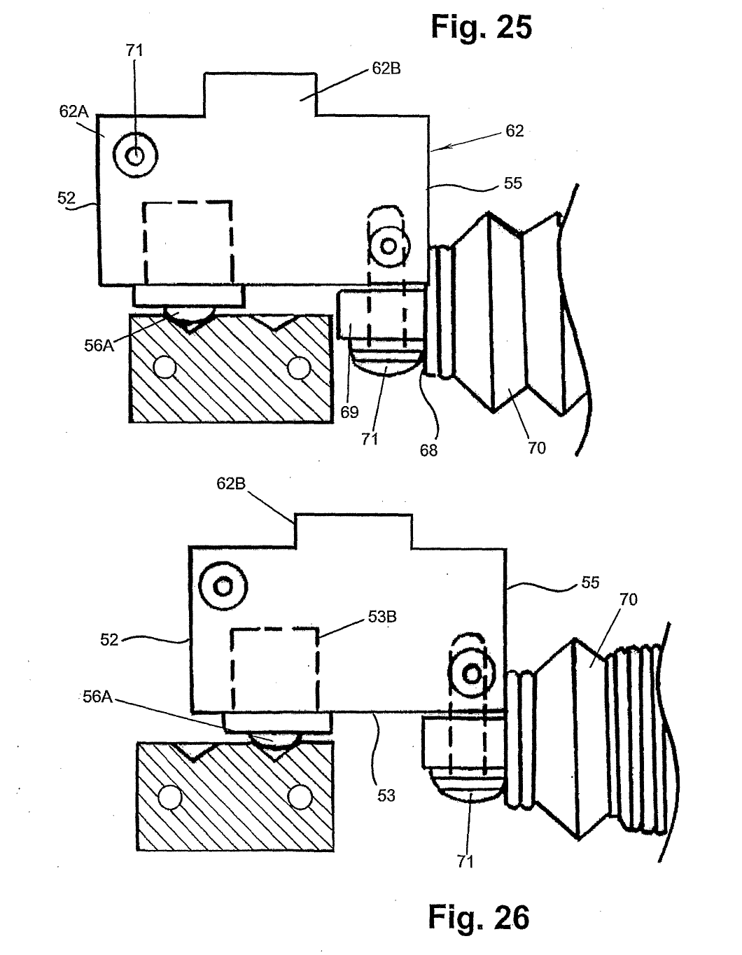

In another form, the tongue member 62 as shown in FIGS. 20 to 26 can be of a substantially T-shaped configuration such as for example a flange. The T-shaped configuration can be made up of a cross-piece 62A and a stem 62B. In cross-piece 62A, there can be provided openings 62C to receive fastener members 71.

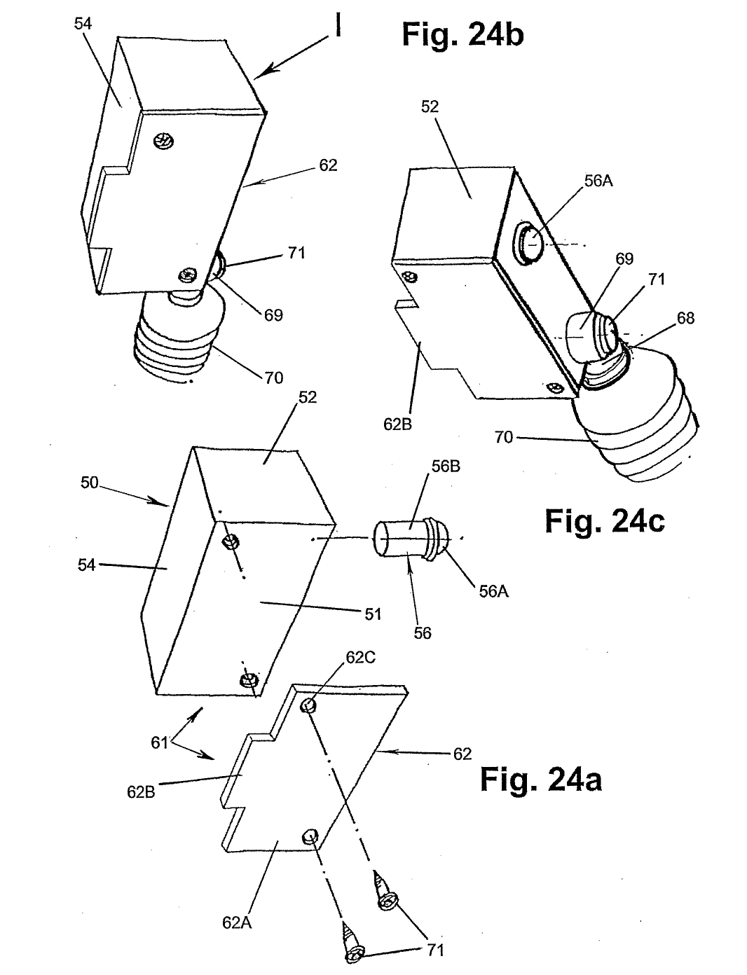

As illustrated in FIGS. 24A to 24C the tongue member 62 can be fixable to a support body 50. The support body 50 can be of a substantially rectangular shape and may be of solid, partially solid or even substantially hollow. The tongue member 62 may be of a one-piece construction (not shown) where one of the side walls 51 of the support body 50 has a substantially rectangular flange piece protruding therefrom, which flange piece being similar to stem-piece 62B.

To side wall 51 the tongue member can be releasably mounted via fastening members 71 passing through opening 62C of the tongue member 62 which are aligned with openings 51A in the side wall. The support body 50 has a first end wall 52, a bottom wall 53, a top wall 54 substantially parallel to the bottom wall and a second end wall 55 parallel to the first end wall but perpendicular to the top and bottom walls. Into bottom wall 53 opening recess 53A and 53B are provided. The opening/recess 53A being adapted to receive therein a fastening member 71, which fastening member acts to releasably secure actuator 60 to the tongue member 62. This is achieved by way of passing fastening member 71 through the coupling nose member 69 and by screwing the fastening member 71 which is receivable within the opening/recess 53A. The actuator 60 via is coupling nose 69 is connected to the tongue member 62 whereupon movement of the actuator 60 causes the tongue member to also move. The other opening/recess 53B is located towards the first end wall 52 of the support body 50. This opening recess 53B being adapted to receive a catch means 56. The catch means is preferably a ball catch or stop device or the like wherein the ball 56A is constantly urged outwardly by a spring means (not shown) located within the catch means body 56B.

To the attachment point 33 there can be attached a suitable latch operating mechanism 110 as shown in FIGS. 27 to 29. A rotary force transmitting member 111 is connectable to the attachment point 33 by any suitable means such as placing the transmitting member 110 upon a spindle means 112 and releasably holding the transmitting member 111 thereto by a fastening member such as a securing nut 113. Tension members 114 are secured opposite points to the rotating force transmitting member 111 with each the tensions members 114 extending in opposite directions from the transmitting member 111 from one another.

Each transmission member 114 is spaced from the supporting plate, door, lid etc. 100 by means of spaces 115 and trough which the tension members 114 may pass. The ends 116 of the tension members; 114 are adapted to extend beyond (when in the locked position) and cooperate with and sit behind flange 121 of the tool box 120.

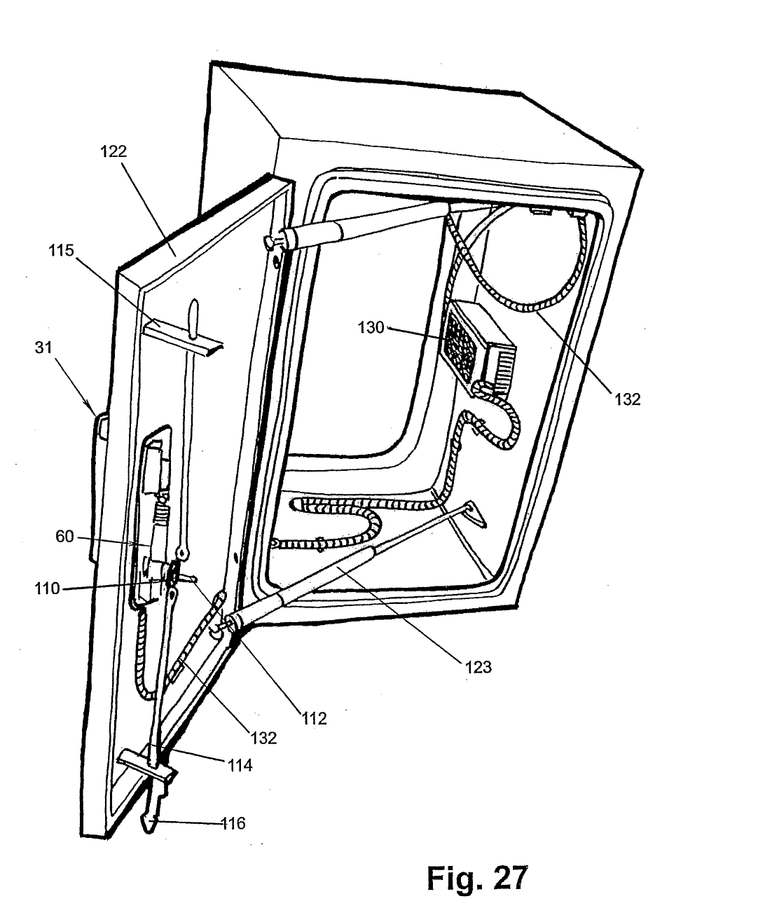

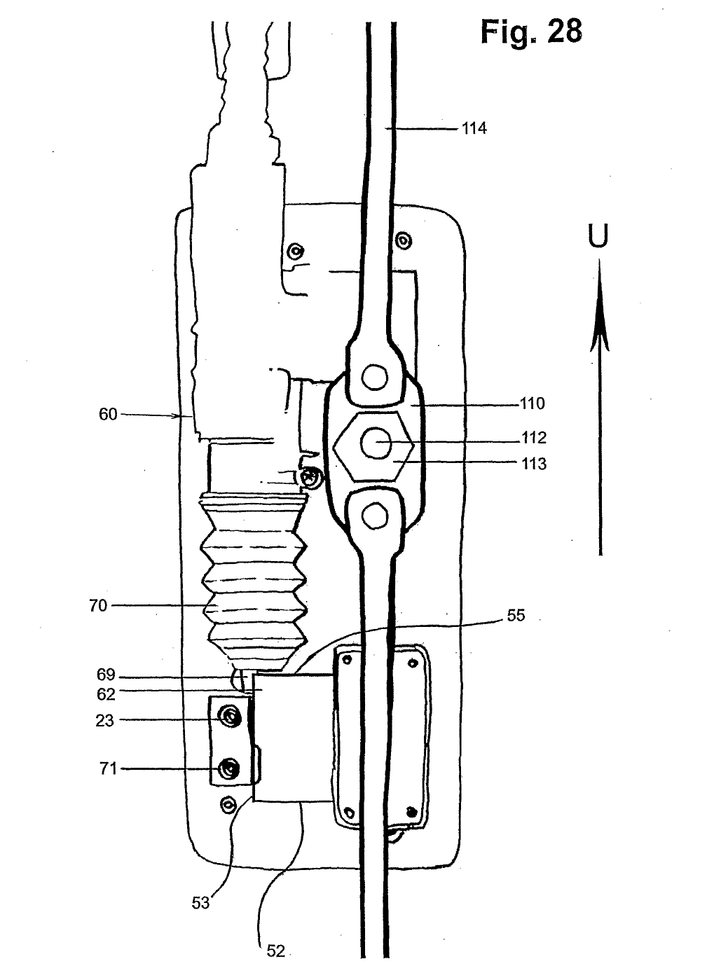

When the swing handle sits in supporting frame 34, the handle assembly is in a locked position such that the rotary force transmitting member 111 is substantially aligned as shown in FIG. 28 relative to the actuator 60. In addition, the tension members 114 are substantially aligned with one another. In this form the overall distance between the ends 116 of the tension members 114 relative to one another is at its greatest. When the tool box lid 122 is closed and the handle assembly is in a locked position, the ends 116 of the tensions members 114 sit behind the tool box flanges 121 thereby locking the tool box.

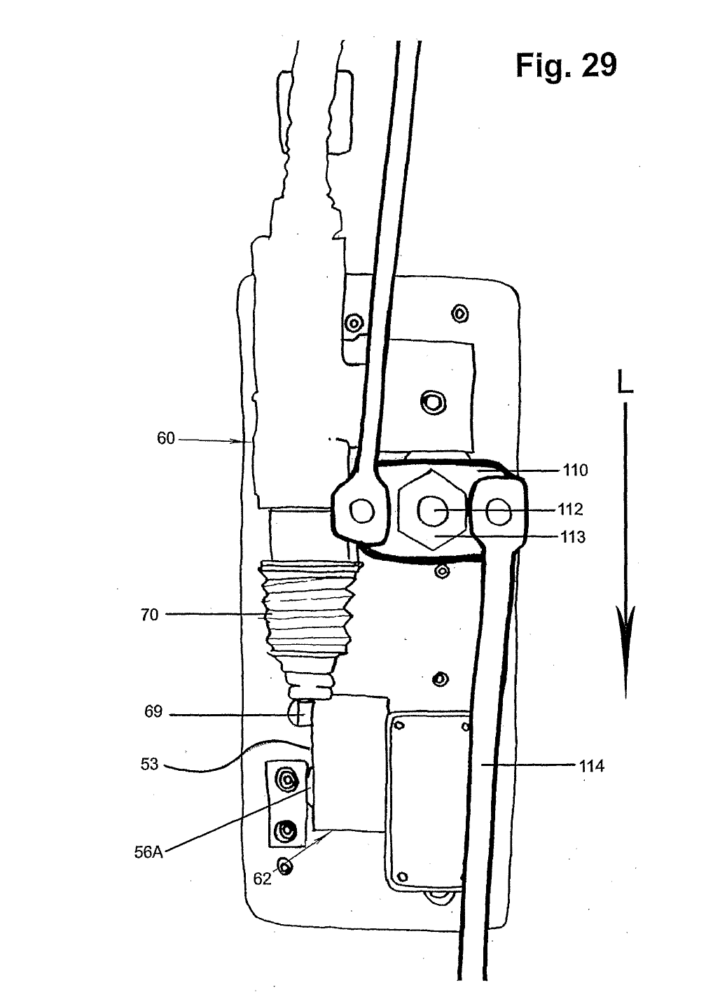

When the tool box 120 and handle assembly 110 are in an unlocked condition whereby the swing handle 32 is free to pivot about attachment point 33, rotation of the swing handle as in FIG. 29 causes simultaneous rotation of the spindle means 112 and thus the rotating force transmitting member 111 attach thereto. Through movement of the swing handle 32 in a clockwise or anticlockwise manner the transmitting member III similarly rotates and thus causes the tension members 114 to retract from behind the tool box flanges 121. If the swing handle is moved sufficiently the ends 116 of the tension members 114 can be retracted fully from behind the tool box phalanges 121 thereby permitting the lid 122 of the tool box 120 to be opened. In the embodiment shown in FIG. 29 this tool box 120 contains receiver 130 of a central locking system device, normally this receiver 130 would be positioned within the motor vehicle body structure and out of sight. The tool box 120 contains pressurized struts 123 which when the lid 122 is permitted to open these automatically raise the lid 122 into the open condition to permit entry into the tool box. The receiver 130 is connected by wires 131 normally enclosed within a casing or conduit 132 to actuator 60 which wise carry the control input thereto. The control input being a locked signal or an unlock signal. The signal received by the actuator triggers the solenoid or motor into action whereby the working end of the actuator is moved forwardly or backwardly and depending on whether the forward motion results in the actuator acting on the tongue member to position itself in a locked or unlocked position is dependant upon the required arrangement of the tongue member. However, in any event the next desired signal will trigger the opposite signal whether it is from locked to unlocked to locked.

Accordingly, with the present device, one can always place the handle assembly 31 in a locked condition. The swing handle 32 is then able to be lifted out of its supporting frame 34 depending on whether the tongue member 62 of the actuator 60 inhibits the lock pawl 92 or 94 from being lifted out of chamber 37. If the tongue member 62 via its bottom web portion 65 or the position of the stem-piece 62B sufficiently protrudes into the inside of chamber 37 and thus overlies lock pawl 92 and as a result hinders lock pawl 92 or 94 from being removed from chamber 37, the locking arrangement 10 is in a locked condition. If the bottom web portion 65 or stein-piece 62B is sufficiently retracted such that it no longer hinders the lock pawl 92 or 94 from being removed from chamber 37, the locking arrangement 10 is in unlocked condition, even though the lock pawl 92 is in its locked position P.

With either the above scenarios, one can always leave the lock pawl 92 or 94 in a locked position P and a decision on whether the locking arrangement 10 is to be locked or unlocked is dependant upon whether the actuator 60 is placed in a locked or unlocked condition. Alternatively, when the actuator 60 is in an extended condition with its bottom web portion 65 or the stem-piece 62B extending sufficiently into the inside of chamber 37, by turning an appropriate key for the locking mechanism 90 and thereby actuating the lock pawl 92 or 94 to move from its locked position P to its unlocked position R, the swing handle 32 can be lifted out of the support chamber 34 enabling if need be, rotation of the handle assembly 32 to open the door, lid or the like to which it is fitted. Accordingly, without disturbing any other locked access points like doors, lids etc. by deactivating the vehicle's central locking system, one is able to open an individual door, lid or the like.

In addition, if the lock pawl 92 or 94 is placed in the locked position P, one can simply by deactivating (i.e. unlocking) the central locking system render all or one or more of the doors, lids, or the like openable. This latter option therefore negates the need for the end-user to have to check that each door, lid, etc. is locked. Securement of any door, lid, etc. is achieved by arming (activating) the central locking system.

An advantage of the present system is that should all access points like the doors, lids, etc. be locked with the actuator 60 in a locked condition (i.e. bottom web portion 65 or the stem-piece 62B hindering lock pawl 92 or 94) and there is a battery failure whereby the vehicle's central locking system cannot be deactivated or cannot work, the end user can still gain access to each door, lid, by using the door's relevant key. Having opened die door, lid, etc. one can then use the same key to lock the door, lid, etc. The vehicle's central locking system can further be programmed to lock or unlock one or more doors, lids, etc at a time.

To further assist in holding the swing handle 32 in contact with its supporting frame 34 when positioned or located within the supporting frame 34, there is preferably provided a retaining means 40. Another embodiment of the retaining means is that as shown as retaining means in 81 and 82A and 823 in FIG. 23 the retaining means 40 and 81, 82A and 82B aid in maintaining contact between the swing handle 32 and frame 34 when the device of the invention is in an unlocked condition i.e., when the tongue member 62 no longer overlies and inhibits/hinders lock pawl 92 or 94 or when lock pawl 92 or 94 is in its unlocked R position.

The handle assembly and thus its swing handle 32 is often mounted in a vertical condition on a vehicle's door or compartment, such that when the swing handle 32 is not locked to its supporting frame 34 and the vehicle is in motion, for example when turning a corner, the swing handle 32 can due to the force of the turn be caused to lift out of the supporting frame 34. If the vehicle travels over uneven ground, the swing handle 32 could also possibly be caused to jump out of the supporting frame 34. In these situations, the swing handle 32 can cause an annoying rattle. The retaining means 40 and 81, 82A and 821B act to decrease the likelihood of the unlocked swing handle 32 dislodging and causing an unwanted noise.

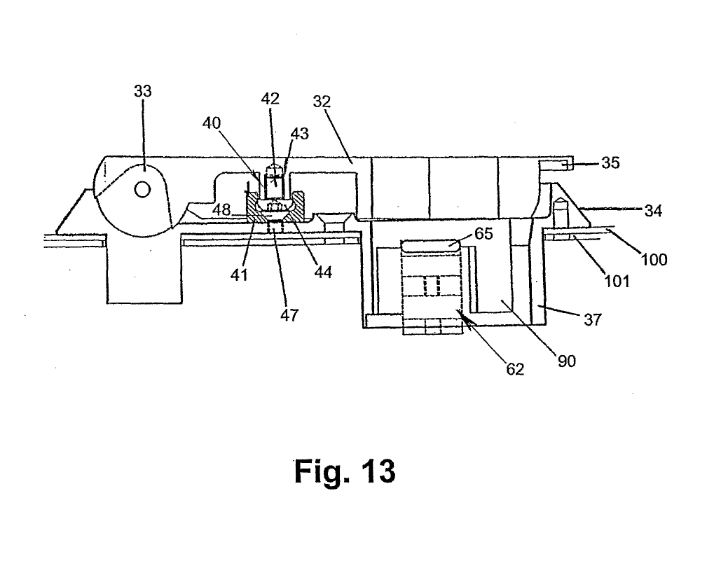

The retailing means 40 can be as simple as relying upon a snap- or quick-fit engagement or even magnetism between associated parts or through friction fit. In the snap- or quick-fit arrangement, as in FIGS. 1 to 14 a suitable female member 41 can be positioned on the base of the supporting frame 34 or to the underside of the swing handle 32. The retaining means 40 preferably also includes a male member 424 which is releasably receivable within the suitable female member 41. In a preferred form, when die male member 42 is positioned on the underside of the swing handle 32, the cooperating female member 41 is aligned thereto and positioned on the supporting frame 34. However when the male member 42 is located on the supporting frame 34, then the female member 41 is aligned with and positioned on the underside of the swing handle 32. In the embodiment shown in FIG. 13, the female member 41 is attachable to the supporting frame 34 while the male member 42 aligned therewith is on the underside of the swing handle 32. The male member 42 can be as simple as a threaded fastener 43 having a suitably shaped round head 44. The female member 41 preferably has a substantially obconic recess 45 within a suitable block of material 46, preferably a plastics material, and into which recess 45 the rounded-head 44 of the male member 42 is able to be releasably received and held. Again the female member 41 can itself be releasably secured to the supporting frame 34 via suitable fastening means such as a threaded bolt 47, preferably having a countersunk head 48, which bolt 47 is receivable within recess 45 and is thus able to be screwed and held onto supporting frame 34.

Instead of the snap- or quick-fit arrangement, one or more, preferably a pair of suitable magnets as designated as retaining means 81, 82A and/or 82B one or more of these may be provided and affixed to the relevant underside of the swing handle 32 as plate 81 and/or to the exposed base of the supporting frame 34 as magnets 82A and 82B. In the friction fit arrangement now shown, the provision of grub rubbers which can be affixed to the inside surface of the chamber 37 and/or to an aligned region on the swing handle can act to frictionally hold the swing handle in contact with its supporting frame. The retaining means can even be a combination of these preferred arrangements.

The earlier disadvantages detailed in relation to previous locking mechanisms can be overcome or at least substantially ameliorated as can be seen by the present invention.

Where the terms “comprise”, “comprises”, comprised” or “comprising” are used in this specification, they are to be interpreted as specifying the presence of the stated features, integers, steps or components referred to, but not to preclude the presence or addition of one or more other feature, integer, stop, component or group thereof.

Those skilled in the art will appreciate that although the invention described herein for simplicity's sake has referred in particular to delivery trucks, it has a general applicability to motor vehicles in general. It is to be understood that the invention includes all variations and modifications of the features identified, including all types of remote control devices, handles and locks referred to or indicated in the specification individually or collectively and any and all combinations of any two or more of said features.

1-14. (canceled)

15: A locking arrangement comprising a lockable swing handle assembly having an independent locking mechanism, which mechanism cooperates with an engagement means operable by an actuator said actuator itself being operable by a vehicle's central locking system, wherein when the engagement means is placed in lockable contact with the locking mechanism of the handle assembly by the actuator, the locking arrangement is placed in a locked condition.

16: The locking arrangement according to claim 15, wherein the swing handle assembly comprises a swing handle and a supporting frame therefor where the swing handle supports the lockable locking mechanism, which mechanism comprises a movable pawl being separately movable relative to the locking mechanism between a locked and an unlocked position.

17: The locking arrangement according to claim 16, wherein the lockable contact between the engagement means and the substantially outwardly extending pawl occurs when the engagement means and pawl contact one another.

18: The locking arrangement according to claim 16, wherein the supporting frame has a frame chamber located therebeneath and into which the locking mechanism is receivable and the pawl is able to be moved into its locked position therein.

19: The locking arrangement according to claim 15, wherein the engagement means comprises a tongue member adapted to at least partially overlie the pawl when the pawl is located therebeneath.

20: The locking arrangement according to claim 19, wherein the frame chamber has a slot therein through which the tongue member is able to protrude into the inside of the frame chamber, whereby the tongue member is movable within and/or along the slot between a first position where the tongue member is contactable by the substantially outwardly extending pawl rendering the locking arrangement locked and a second position where the tongue member is no longer contactable with the pawl thereby rendering the locking arrangement unlockable.

21: The locking arrangement according to claim 16, wherein the engagement means is directly or indirectly connected to the actuator whereupon when the actuator in response to a first signal from the central locking system moves to a first position, the engagement means correspondingly moves into a lockable contact position with the pawl; and whereupon when the actuator in response to a second signal from the central locking system moves to a second position, the engagement means is correspondingly moved to a position whereby there is no lockable contact with the pawl.

22: The locking arrangement according to claim 19, wherein the tongue member is mounted on or is connectable to a supporting body which body is coupled at one end to the actuator, wherein the other end of the supporting body cooperates with a guide member which assists in alignment positioning and/or containment of the tongue member within the slot in the frame chamber.

23: The locking arrangement according to claim 20, wherein the tongue member comprises a guide means located therein or thereon to assist in alignment positioning and/or containment of the tongue member within the slot in the frame chamber.

24: The locking arrangement according to claim 15, wherein movement of the actuator is electromagnetically actuated.

25: A locking system comprising at least one of access points wherein the at least one access points is cooperable with at least an equal number of the locking arrangements wherein each at least one locking arrangements further comprises a lockable swing handle assembly having an independent locking mechanism, which mechanism cooperates with an engagement means operable by an actuator said actuator itself being operable by a vehicle's central locking system, wherein when the engagement means is placed in lockable contact with the locking mechanism of the handle assembly by the actuator, the locking arrangement is placed in a locked condition, such that the locking arrangements when in a locked condition prevents entry into or through the at least one access points and when the at least an equal number of locking arrangements is in an unlocked condition, it permits entry into or through the at least one each access points being rendered in the unlocked condition.

26: A locking system according to claim 25, wherein the at least one access points are selected from the group consisting of doors, lids, tops, covers, hatches and combinations thereof.

27: A locking system according to claim 25, wherein at least one of the locked access points is unlockable while at least one other access points remain in the locked condition.

28: A method of reversibly locking via a locking arrangement at least one lockable vehicle access point, the vehicle having a central locking system, wherein the locking arrangement mountable on said access point comprises a swing handle assembly having an independently lockable locking mechanism and an engagement means operable by an actuator said actuator itself being operable by the central locking system,
wherein the method to lock the access point comprises:
activating the actuator by a first signal from the central locking system to bring the engagement means into contact with the locking mechanism of the handle assembly and thereby placing the locking arrangement and the access point on which it is mounted into a locked condition thereby preventing entry to or through the access point;
and wherein the method to unlock the access point either comprises:
activating the actuator by a second signal from the central locking system to break the contact between the engagement means and the locking mechanism, thereby placing the locking arrangement and the access point in an unlocked condition
or
unlocking the independently lockable locking mechanism of the handle assembly to break the contact between the engagement means and the locking mechanism, thereby permitting entry to or through the access point.

29: The method according to claim 28, wherein the actuator is electromagnetically actuated.
